(19) United States
(12) Patent Application Publication
(10) Pub. No.: US 2006/0253788 A1
(43) Pub. Date: Nov. 9, 2006

(54) Method, apparatus and computer program to provide a display screen button placement hint property

(75) Inventors: Aleksi Uotila, Tampere (FI); Tuija Lindfors, Tampere (FI); Auli Joki, Lakiala (FI)

Correspondence Address: HARRINGTON & SMITH, LLP, 4 RESEARCH DRIVE, SHELTON, CT, 06484-6212, US

(73) Assignee: Nokia Corporation

(21) Appl. No.: 11/124,651

(22) Filed: May 9, 2005

(51) Int. Cl. G06F 9/00

(52) U.S. Cl. 715/762

(57) ABSTRACT

Disclosed is a method to develop a graphical user interface that includes entering a data structure that specifies a preferred form of a Button to appear on a display screen, and in response to the data structure, defining at least one of a displayable Button placement for a specific instance of a display screen, or the use of another user input mechanism, such as a softkey, in place of a displayable Button for the specific instance of the display screen. Also disclosed is a graphical user interface development system that includes means for receiving a data structure that specifies a preferred form of a Button to appear on a display screen and means, responsive to the data structure, for defining at least one of a displayable Button placement for a specific instance of a display screen, or the use of another user input mechanism in place of a displayable Button for the specific instance of the display screen. Also disclosed is a mobile device that has a graphical user interface that includes a display screen, where the graphical user interface is defined at least in part by the use of a Button property string that is interpreted at least in part based on physical characteristics of at least one of the display screen and the mobile device.

### TECHNICAL FIELD

The embodiments of this invention relate generally to user interface (ULI) devices and methods and, more specifically, relate to graphical user interfaces that are especially appropriate for use with display screen that have a limited viewing area.

### BACKGROUND

An issue that arises during the development of a graphical user interface relates to the placement of application-drawn (graphical) “Buttons”, i.e., defined screen areas wherein a user may by touching enter data or initiate a command. Some conventional graphical desktop application development environments (e.g., Java™ AWT/Swing/SWT etc.) simply draw a Button where the application defines it. Another UI development environment uses this same concept in the context of a mobile device, such as a cellular telephone, or a personal digital assistant (PDA). However, in the mobile device UI the available screen may not be a touch screen that allows direct activation of a button by clicking it. Also the display screen may be so small that the usability of an application suffers if the Button is drawn, as area required for the Button subtracts from the total screen area available for the application.

It is known in some mobile devices UIs, such as in cellular telephones, that a UI construct (basically a command to do something) can be presented as an operation under a softkey or options menu, as on-screen Buttons are not normally used at least due to the limited available display screen area.

A problem is thus presented in that there are mobile device UI display screens on which it is not practical to draw a graphical Button, due at least to the screen not being touch sensitive and/or the screen area being too limited, without adversely affecting software application usability and portability.

### SUMMARY OF THE PREFERRED EMBODIMENTS

The foregoing and other problems are overcome, and other advantages are realized, in accordance with the examples of this invention.

In one aspect thereof this invention provides a method to develop a graphical user interface that includes entering a data structure that specifies a preferred form of a Button to appear on a display screen, and in response to the data structure, defining at least one of a displayable Button placement for a specific instance of a display screen, or the use of another user input mechanism, such as a sofikey, in place of a displayable Button for the specific instance of the display screen.

In another aspect thereof this invention provides a graphical user interface development system that comprises means for receiving a data structure that specifies a preferred form of a Button to appear on a display screen and means, responsive to the data structure, for defining at least one of a displayable Button placement for a specific instance of a display screen, or the use of another user input mechanism in place of a displayable Button for the specific instance of the display screen.

In a further aspect thereof this invention provides a device that comprises a graphical user interface that comprises a display screen, where the graphical user interface is defined at least in part by the use of a Button property string that is interpreted at least in part based on physical characteristics of at least one of the display screen and the mobile device. The physical characteristics can comprise whether the display screen is a touch-sensitive display screen, and/or a size of the display screen, and/or whether a softkey is available. In a non-limiting embodiment the Button property string is comprised of “component-displacement-hint”.

In another aspect thereof this invention provides a computer program product embodied on a tangible computer-readable medium an execution of which causes a computer to perform operations of: enter a data structure that specifies a preferred form of a Button to appear on a display screen and, in response to the data structure, define at least one of a displayable Button placement for a specific instance of a display screen, or the use of another user input mechanism in place of a displayable Button for the specific instance of the display screen.

### BRIEF DESCRIPTION OF THE DRAWINGS

The foregoing and other aspects of the teachings of this invention are made more evident in the following Detailed Description, when read in conjunction with the attached Drawing Figures, wherein:

FIG. 1 is a high level conceptual view of a UI development environment and a mobile device having a UI to be developed; and

FIG. 2 is a logic flow diagram of a method in accordance with non-limiting embodiments of this invention.

### DETAILED DESCRIPTION

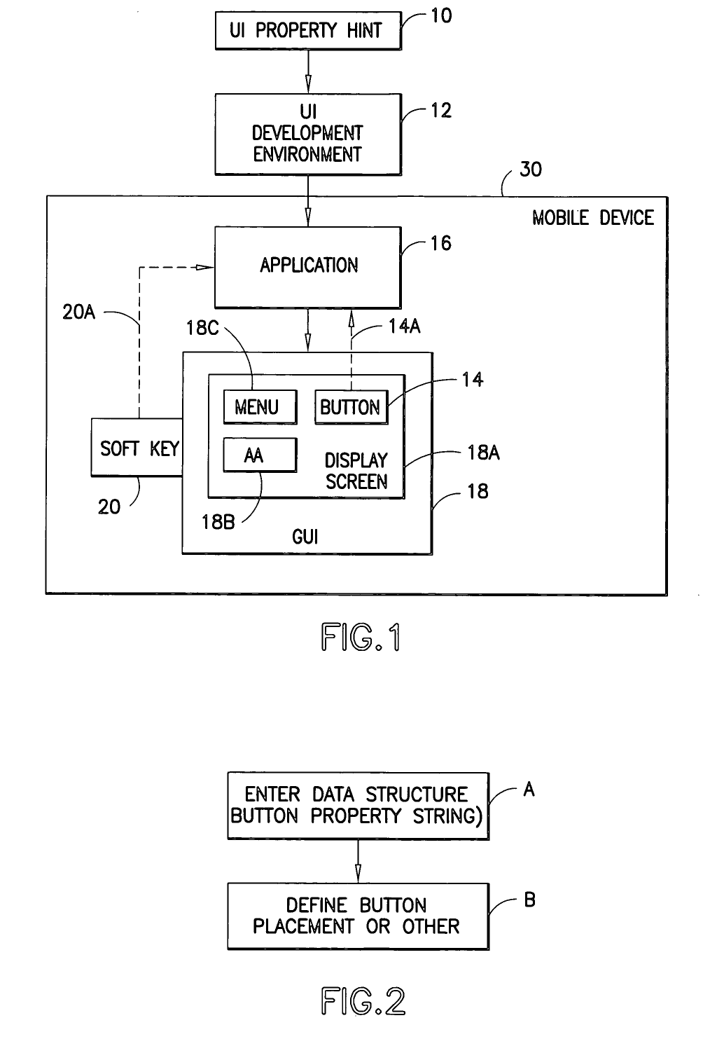

Referring to FIG. 1, the embodiments of this invention provide a UI property hint 10 that an underlying UI development environment 12 may employ to determine whether a Button 14 should be drawn, as it is defined by an application 16 for its graphical user interface (GUI) 18, if the available device UI screen 18A is a touch screen (or otherwise suitable for use with the Button 14), or whether the Button 14 should instead be placed under a device softkey 20 as a command if the available device UI screen 18A is not a touch screen (or otherwise impractical, such as due to limited viewing area), and a softkey 20 is available. Whether the Button 14 or the softkey 20 are used, activating either results in an output 14A, 20A that is detectable by the application 16, and which may then take some defined action in response thereto. The application 16 and GUI 18 are assumed to be embodied during use in a mobile device 30. The screen 18A may also be considered to include an application area (AA) 18B, and possibly a displayable menu 18C.

In general, the various embodiments of the mobile device 30 can include, but are not limited to, cellular telephones, personal digital assistants (PDAs), portable computers, image capture devices such as digital cameras, gaming devices, music storage and playback appliances, Internet appliances permitting wired and/or wireless Internet access and browsing, as well as portable units or terminals or devices that incorporate combinations of such functions.

The UI property hint 10 may also be employed to force the underlying UI development environment 12 to always draw the Button 14, even if the device UI screen 18A is not a touch screen (or otherwise impractical). In addition, the UI property hint 10 may also be employed to force the underlying UI development environment 12 to always define the Button 14 with a touch screen 18A softkey 20, assuming that a softkey 20 is available in which the Button 14 may be added as a command.

In an embodiment of this invention the UI property hint 10 may be implemented as a property string, or with any other suitable data object, that can be read by the underlying UI development environment 12 and preferably manipulated by an application developer. It is noted that in many UI Application Program Interfaces (APIs) there is generic mechanism present to set properties to UI components. The actual implementation of the UI property hint 10 is dependent on the property mechanism of a development GUI toolkit.

As a non-limiting example, the UI property hint 10, when implemented as a property string, may have the form: “component-displacement-hint”, with values such as “softkeys” and “on-screen”. This property string is treated as a “hint”, and the “displacement” is used only if it makes sense in the actual implementation. For example, if there is no softkey 20, and the softkey displacement hint is used in the property string, then it is ignored.

More specifically, there is defined a property name/value pair. The property name may be, for example, “component-displacement”, and suitable values may be, as non-limiting examples, “default”, which places the component (Button 14) to, for example, a softkey 20 or to a menu in a non-touch screen 18A, or that presents the Button 14 in an application area 18B on a touch display screen 18A. A value of “softkey” explicitly states that the component should be placed to the softkey 20. A value of “menu” explicitly states that the component should be placed to, i.e., should form an element of, a menu 18C. A value of “app_area” explicitly states that the component should be in the application's 16 client area 18B on the display screen 18A, where it is positioned by application 16. This latter value may be considered to be equivalent to a null/no-value “component-displacement” property.

It is pointed out that how these property values are actually used depends on the UI API in question, but often there is provided a construct similar to a setProperty(String name, String value) method in the generic component class.

It is also pointed out that the UI API may have a construct similar to setProperty(String name, String value) as described. However, in other non-limiting embodiments of this invention the property may be set manually (i.e., not through the UI API) in a property file, and it is then read by the corresponding Java UI library implementation (such as eSWT/AWT/Swing) at system startup.

One suitable and non-limiting GUI toolkit for use in the UI development environment 12 is one known as eSWT (under development), also known as Embedded SWT, based on Standard Widget Toolkit (SWT) available from Eclipse Foundation (http://www.eclipse.org). As is presently specified in Section 1.4.4, Layout Management, in a document entitled: eSWT Requirements and High-Level Architecture (Sep. 25, 2004), a Composite class is one that holds one or more UI components. Composite has a Layout object responsible for laying out contained components. If no layout is set by the application (layout is null) then the components can be sized and positioned within the composite by their absolute coordinates relative to the composite origin. In Section 1.4.7, Widgets, a Button is defined as allowing user interaction such as pressing and releasing. Three Button styles are currently defined: PUSH (normal button), CHECK (on/off states) and RADIO (on/off depending on other RadioBoxes in the same RadioBox group).

Note, however, that eSWT does not have currently have a method setProperty(String name, String value) in its Composite class.

Note further that a property method in eSWT/SWT Component, referred to as setData( ), has the form:

public void setData(java.lang.Object data)

public void setData(java.lang.String key, java.lang.Object value)

In the non-limiting example of the eSWT UI development environment 12 the UI property hint 10 (Button 14) placement hint aids the application developer in giving information (a hint) to the underlying UI development environment 12 to determine where and when a Button 14 is placed in different mobile device screens (e.g., draw in the screen 18A or place under a softkey 20), and thus improves usability and portability of applications between different mobile devices having different display screen 18A and softkey 20 characteristics.

Referring to FIG. 2, and in view of the foregoing description, it can be appreciated that this invention in one aspect thereof provides a method to develop a graphical user interface that includes (Block A) entering a data structure 10 that specifies a preferred form of a Button 14 to appear on a display screen 18A, and in response to the data structure, (Block B) defining at least one of a displayable Button placement for a specific instance of a display screen 18A, or the use of another user input mechanism, such as the softkey 20, in place of a displayable Button for the specific instance of the display screen 18A.

A computer program that operates in accordance with the foregoing method, and that may be stored on a memory that is accessible by a data processor of the UI development environment 12, is also an aspect of this invention.

Thus, certain embodiments of this invention may be implemented by computer software executable by a data processor of the UI development environment 12, or by hardware, or by a combination of software and hardware. Further in this regard it should be noted that the various blocks of the logic flow diagram of FIG. 2 may represent program steps, or interconnected logic circuits, blocks and functions, or a combination of program steps and logic circuits, blocks and functions.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. As but one example, the use of other similar or equivalent UI development environments may be attempted by those skilled in the art. As another example, the teachings of this invention apply to both mobile and non-mobile devices, such as ATM machines as a non-limiting example. Also, the Button property string may have a form that deviates from the one described above. However, all such and similar modifications of the teachings of this invention will still fall within the scope of this invention.

Furthermore, some of the features of the examples of this invention may be used to advantage without the corresponding use of other features. As such, the foregoing description should be considered as merely illustrative of the principles, teachings, examples and embodiments of this invention, and not in limitation thereof.

What is claimed is:

1. A method to develop a graphical user interface, comprising:
entering a data structure that specifies a preferred form of a Button to appear on a display screen; and
in response to the data structure, defining at least one of a displayable Button placement for a specific instance of a display screen, or the use of another user input mechanism in place of a displayable Button for the specific instance of the display screen.

2. A method as in claim 1, where the other user input mechanism comprises a softkey.

3. A method as in claim 1, where the other user input mechanism comprises a menu.

4. A method as in claim 1, where the other user input mechanism comprises a displayable user input mechanism.

5. A method as in claim 1, where the data structure comprises a property string comprised of “component-displacement-hint”.

6. A graphical user interface development system, comprising:
means for receiving a data structure that specifies a preferred form of a Button to appear on a display screen; and
means, responsive to the data structure, for defining at least one of a displayable Button placement for a specific instance of a display screen, or the use of another user input mechanism in place of a displayable Button for the specific instance of the display screen.

7. A graphical user interface development system as in claim 6, where the other user input mechanism comprises a softkey.

8. A graphical user interface development system as in claim 6, where the other user input mechanism comprises a menu.

9. A graphical user interface development system as in claim 6, where the other user input mechanism comprises a displayable user input mechanism.

10. A graphical user interface development system as in claim 6, where the data structure comprises a property string comprised of “component-displacement-hint”.

11. A device comprising a graphical user interface that comprises a display screen, the graphical user interface being defined at least in part by the use of a Button property string that is interpreted at least in part based on physical characteristics of at least one of the display screen and the device.

12. A device as in claim 11, where the physical characteristics comprise a touch-sensitive display screen.

13. A device as in claim 11, where the physical characteristics comprise a size of the display screen.

14. A device as in claim 11, where the physical characteristics comprise whether a softkey is available.

15. A device as in claim 11, where the Button property string is comprised of “component-displacement-hint”.

16. A device as in claim 11, where said device is a mobile device.

17. A device as in claim 11, where said device is a mobile communications device.

18. A computer program product embodied on a tangible computer-readable medium an execution of which causes a computer to perform operations of:
enter a data structure that specifies a preferred form of a Button to appear on a display screen; and
in response to the data structure, define at least one of a displayable Button placement for a specific instance of a display screen, or the use of another user input mechanism in place of a displayable Button for the specific instance of the display screen.

19. A computer program product as in claim 18, where the other user input mechanism comprises a softkey.

20. A computer program product as in claim 18, where the other user input mechanism comprises a menu.

21. A computer program product as in claim 18, where the other user input mechanism comprises a displayable user input mechanism.

22. A computer program product as in claim 18, where the data structure comprises a property string comprised of “component-displacement-hint”.
